(19) United States
(12) Patent Application Publication
(10) Pub. No.: US 2012/0188343 A1
(43) Pub. Date: Jul. 26, 2012

(54) IMAGING APPARATUS

(75) Inventors: YOSHIHIKO MATSUURA, Osaka (JP); YOSUKE YAMANE, Osaka (JP)

(73) Assignee: PANASONIC CORPORATION, Osaka (JP)

(21) Appl. No.: 13/354,413

(22) Filed: Jan. 20, 2012

(30) Foreign Application Priority Data
Jan. 24, 2011 (JP) 2011-011663
Feb. 15, 2011 (JP) 2011-029369

(51) Int. Cl. H04N 13/02

(52) U.S. Cl. 348/46; 348/E13.074

(57) ABSTRACT

An imaging apparatus includes an imaging unit configured to capture a subject to generate an image, a detector configured to detect tilt of the imaging apparatus; a storage unit configured to store the images generated by the imaging unit with the images being related to the detection results of the detector, and a controller configured to select at least two images as images for generating a three-dimensional image from the plurality of images stored in the storage section based on the detection results related to the images.

### BACKGROUND

1. Technical Field

The technical field relates to an imaging apparatus, and particularly relates to the imaging apparatus for capturing a plurality of images to generate a three-dimensional image.

2. Related Art

In recent years, along with spread of television sets for enabling display of three-dimensional videos, cameras that can record three-dimensional images are known. For example, JP 2003-9183 A discloses a camera that obtains a left-eye image and a right-eye image composing a three-dimensional image from a plurality of pieces of image information generated while a camera is being moved in a horizontal direction with respect to a subject.

### SUMMARY

When taking images for generating a three-dimensional image by moving such camera, the user might move the camera unsuitably for obtaining a left-eye image and a right-eye image. Particularly when a photographing angle is different between a left-eye image and a right-eye image, a left-eye image and a right-eye image that are unsuitable as images for generating a three-dimensional image would be adopted.

In order to solve the above problem, an imaging apparatus is provided, that captures a plurality of images to generate a three-dimensional image, and can obtain images suitable for generating a three-dimensional image even when the plurality of images are captured at different angles.

In order to solve the above problem, an imaging apparatus of the first aspect includes an imaging unit configured to capture a subject to generate an image, a detector configured to detect tilt of the imaging apparatus; a storage unit configured to store the images generated by the imaging unit with the images being related to the detection results of the detector, and a controller configured to select at least two images as images for generating a three-dimensional image from the plurality of images stored in the storage section based on the detection results related to the images.

The imaging apparatus according to the first aspect selects a combination of images based on the detected results of the tilts related to the respective images. As a result, when a plurality of images is captured and a three-dimensional image is generated, even if the plurality of images is captured at different angles, the images suitable for generating a three-dimensional image can be obtained.

### BRIEF DESCRIPTION OF DRAWINGS

FIG. 1 is a front view of a digital camera.

FIG. 2 is a rear view of the digital camera.

FIG. 3 is a diagram of electric configuration of the digital camera.

FIGS. 4A and 4B are diagrams illustrating tilts of the digital camera in a slide 3D recording mode.

FIGS. 5A and 5B are timing charts illustrating tilts of the digital camera in the slide 3D recording mode.

FIG. 6 is an operation flowchart in the slide 3D recording mode.

FIG. 7 is an image selecting flowchart for generating a three-dimensional image.

### DETAILED DESCRIPTION OF PREFERRED EMBODIMENT

A digital camera according to a preferred embodiment will be described below with reference to the accompanying drawings.

### 1. Configuration of Digital Camera

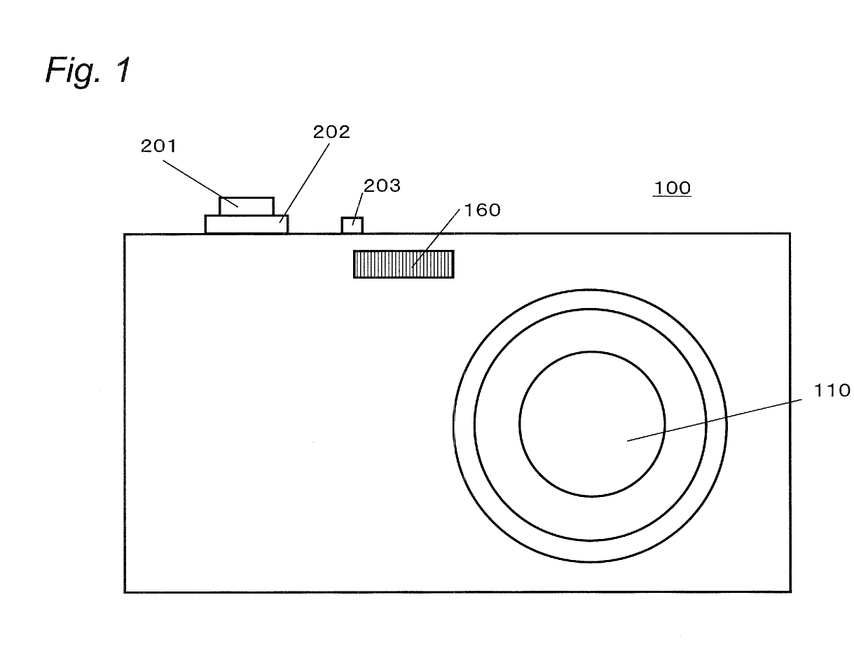

A configuration of the digital camera according to the embodiment will be described with reference to FIG. 1. The digital camera 100 includes a lens barrel for storing an optical system 110, and a flash 160 on its front surface. The digital camera 100 has operation buttons such as a release button 201, a zoom lever 202, and a power button 203 on its upper surface.

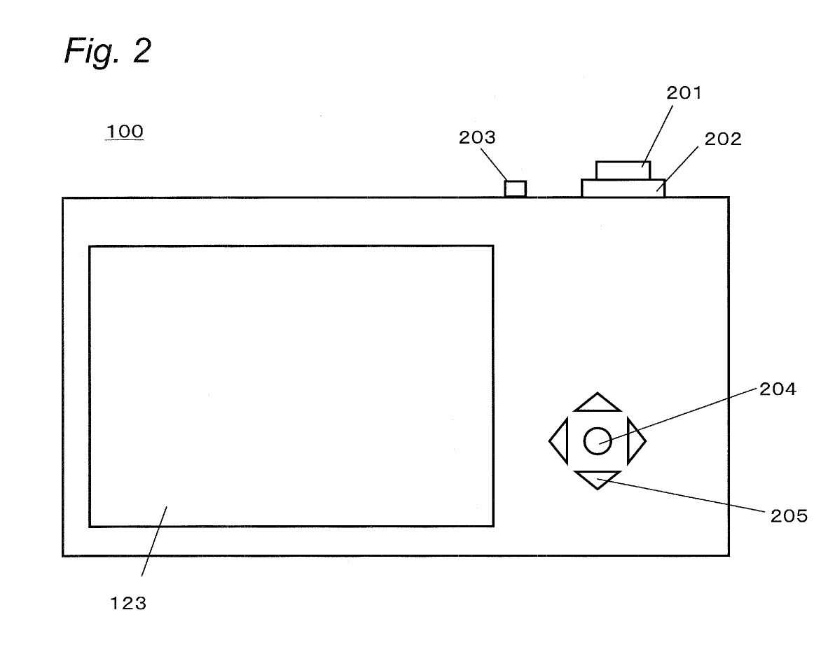

FIG. 2 is a rear view of the digital camera 100. The digital camera 100 has a liquid crystal monitor 123 and operation buttons such as a center button 204 and a cross button 205 on its rear surface.

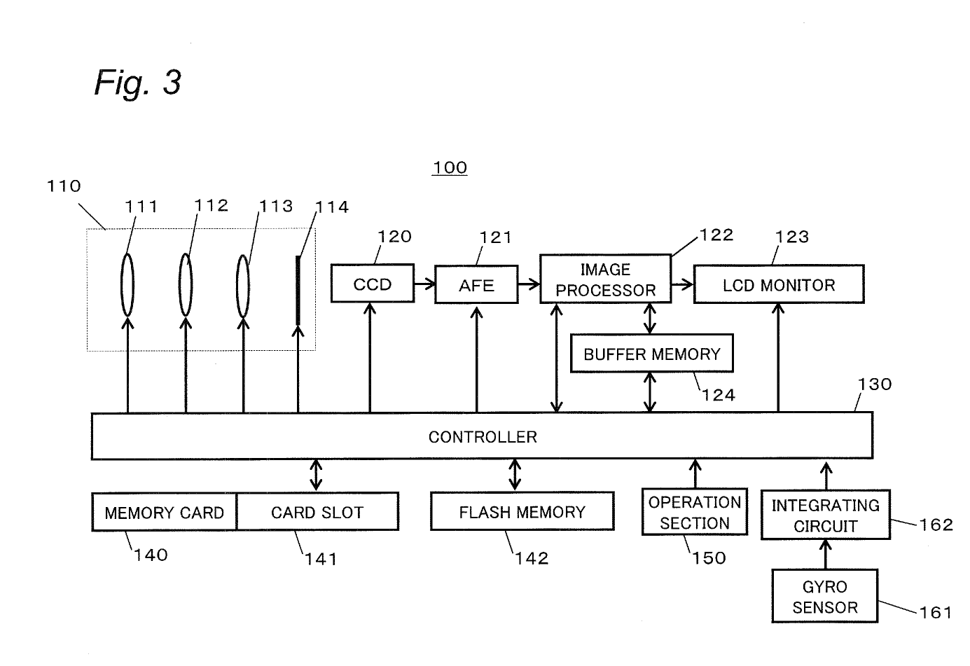

FIG. 3 is a diagram of an electric configuration of the digital camera 100. In the digital camera 100, a subject image formed via the optical system 110 is captured by a CCD image sensor 120. The CCD image sensor 120 generates image information based on the captured subject image. The image information generated by the CCD image sensor 120 is subject to various processes in an AFE (analog front end) 121 and an image processor 122. The image information subject to the various processes is recorded in a flash memory 142 and a memory card 140. The image information recorded in the flash memory 142 and the memory card 140 are displayed on the liquid crystal monitor 123 according to a user's operation on an operation section 150. Respective components shown in FIG. 1 to FIG. 3 will be described in detail below.

The optical system 110 includes a focus lens 111, a zoom lens 112, an optical shake correction lens (OIS: optical image stabilizer) 113, and a shutter 114. The various lenses composing the optical system 110 may be composed of any number of lenses or any number of lens groups.

The focus lens 111 is used for adjusting a focus state of a subject. The zoom lens 112 is used for adjusting a view angle of a subject. The shutter 114 adjusts exposure time of light incident on the CCD image sensor 120. The focus lens 111, the zoom lens 112, the optical shake correction lens 113, and the shutter 114 are driven by the corresponding driving units such as a DC motor or a stepping motor according to control signals sent from a controller 130.

The CCD image sensor 120 captures a subject image formed via the optical system 110 to generate image information. The CCD image sensor 120 generates image information of a new frame at a predetermined frame rate (for example, 30 frames/sec.). The controller 130 controls image data generation timing and an electronic shutter operation of the CCD image sensor 120. The liquid crystal monitor 123 displays this image data one by one as a through image, and thus the user can check a condition of the subject at real time.

The AFE 121 performs repression of noises by correlated double sampling, and gain multiplication based on an ISO sensitivity via an analog gain controller, and AD conversion with an AD converter on image information input by the CCD image sensor 120. Thereafter, the AFE 121 outputs the image information to the image processor 122.

The image processor 122 gives various processes to the image information output by the AFE 121. Examples of the various processes include BM (block memory) integration, smear correction, white balance correction, gamma correction, a YC converting process, an electronic zoom process, a compressing process, and an expanding process, but the various processes are not limited to them. The image processor 122 may be composed of a hard-wired electronic circuit or may be composed of a microcomputer using a program. Further, the image processor 122 as well as another function sections such as the controller 130 may be composed of one semiconductor chip.

A gyro sensor 161 detects blur of the optical system 110 in a yawing direction and in a pitching direction of an optical axis based on an angle change (angular velocity) of the digital camera 100 per unit time. The gyro sensor 161 outputs a gyro signal representing the detected angular velocity to an integrating circuit 162.

The integrating circuit 162 integrates signals (hereinafter, “gyro signals”) representing the angular velocities output from the gyro sensor 161 and generates an integral signal (a signal representing an angle) to output the integral signal to the controller 130. Receiving the integral signal output from the integrating circuit 162, the controller 130 can recognize rotation angles in the yawing direction and the pitching direction of the optical system 110 of a casing. Before the integrating circuit 162 executes an integrating process on the gyro signal, the integrating circuit 162 may cut off an unnecessary DC component, amplify the gyro signal whose DC component is cut off, and cut off a high-frequency component of the amplified signal. Further, an angle represented by the signal output from the integrating circuit 162 is, in other word, an angle of the digital camera 100.

The liquid crystal monitor 123 is provided on the rear surface of the digital camera 100. The liquid crystal monitor 123 displays an image based on the image information processed by the image processor 122. The image displayed by the liquid crystal monitor 123 includes a through image and a recorded image. The through image is an image obtained by continuously displaying images of frames generated by the CCD image sensor 120 at every predetermined time. Normally, when the digital camera 100 is in the recording mode, the image processor 122 generates a through image based on the image information generated by the CCD image sensor 120. The user refers to the through image displayed on the liquid crystal monitor 123, so as to perform photographing while checking a composition of a subject. The recorded image is an image that is obtained by reducing a moving image or a still image with high pixel which is recorded in the memory card 140, and so on to a low-pixel size in order to display the moving image or the still image on the liquid crystal monitor 123 when the digital camera 100 is in a reproducing mode.

The controller 130 controls an entire operation of the digital camera 100. The controller 130 may be composed of a hard-wired electronic circuit or a microcomputer, and so on. The controller 130 as well as the image processor 122 may be composed of one semiconductor chip.

The controller 130 supplies exposure timing pulses to the CCD image sensor 120. The CCD image sensor 120 performs a subject image capturing operation according to timing at which the exposure timing pulse is supplied from the controller 130. The controller 130 continuously supplies the exposure timing pulses, and thus the CCD image sensor 120 continuously captures subject images to generate image information. Further, the controller 130 adjusts time intervals of supply of the exposure timing pulses to adjust a continuous recording interval of the CCD image sensor 120.

The controller 130 obtains an integral signal (angle signal) from the integrating circuit 162 in synchronous with the timing at which the exposure timing pulse is supplied to the CCD image sensor 120. A difference (delay) between the timing at which the controller 130 supplies the exposure timing pulse and the timing at which the controller 130 obtains the integral signal can be suitably changed. However, it is desirable that the controller 130 obtains the integral signal according to the timing at which the CCD image sensor 120 generates the image information.

The controller 130 can set the recording mode of the digital camera 100 to a “slide 3D recording mode”. The “slide 3D recording mode” means a recording mode in which the user taking a subject image while moving the digital camera 100 so that a left-eye image and a right-eye image for generating a three-dimensional image can be obtained. For example, the controller 130 sets the recording mode of the digital camera 100 to the slide 3D recording mode according to a user's operation of a menu button. The mode of the digital camera 100 includes also a 2D recording mode and a reproducing mode.

The flash memory 142 functions as an internal memory for storing image information, and so on. The flash memory 142 stores programs relating to auto focus (AF) control, auto exposure (AE) control and light emission control of the flash 160, as well as a program for generally controlling the entire operation of the digital camera 100. The flash memory 142 stores a correspondence table including information representing a relationship between displacement of pixel and a stereo base. “The displacement of pixel” means a difference between a position of a feature region in a certain image and a position of the same feature region in another image captured in the slide 3D recording mode. The difference between the positions is represented by number of pixels. “The feature region” means a characteristic portion (for example, a face region of a person) in an image to be compared for calculating a displacement of pixel. “The stereo base” means a distance between photographing positions of a left-eye image and a right-eye image necessary for generating a 3D image. In the digital camera 100 according to the embodiment, the flash memory 142 stores a correspondence table representing a relationship between the displacement of pixel and the stereo base when a subject is separated 1 meter from the digital camera 100. The controller 130 accesses the correspondence table stored in the flash memory 142 to recognize a correspondence relationship between the displacement of pixel and the stereo base. Further, the flash memory 142 stores reference distance information about the stereo base suitable for user's viewing of a three-dimensional image. “The stereo bases suitable for viewing of the three-dimensional image” means a stereo base with which the user can suitably view the three-dimensional image when the digital camera 100 displays a left-eye image and a right-eye image three-dimensionally. The flash memory 142 stores allowable range information about a relative tilt amount. The relative tilt amount means a difference of the rotation angle in the yawing direction and the pitching direction of the optical axis of the optical system 110 at image capturing time among a plurality of images continuously photographed in the slide 3D recording mode. In other words, it is a difference in the tilt of the digital camera 100. The controller 130 accesses the flash memory 142 to recognize the reference distance information about the stereo base and the allowable range information about the relative tilt amount.

A buffer memory 124 is a storage unit that functions as a work memory of the image processor 122 and the controller 130. The buffer memory 124 can be realized by DRAM (Dynamic Random Access Memory), and so on.

A card slot 141 is a connecting unit to/from which the memory card 140 is attachable/detachable. The card slot 141 can electrically or mechanically connect the memory card 140. Further, the card slot 141 may have a function for controlling the memory card 140. The memory card 140 is an external memory containing a storage device such as the flash memory. The memory card 140 can store data such as image information to be processed by the image processor 122.

The operation section 150 is a general name of operation buttons and operation levers provided to the casing of the digital camera 100, and receives user's operations. The operation section 150 includes, for example, the release button 201, the zoom lever 202, the power button 203, the center button 204, the cross button 205 and the like shown in FIG. 1 and FIG. 2. The operation section 150 notifies the controller 130 of an operation instructing signal according to a user's operation.

The release button 201 is a pressing-down button that has two-stage states including a half-pressing state and a full-pressing state. When the release button 201 is half-pressed by the user, the controller 130 makes an autofocus control and an automatic exposure control so as to determine recording conditions. Thereafter, when the release button 201 is full-pressed by the user, the controller 130 records image information generated by the CCD image sensor 120 at full-press timing as a still image in the memory card 140.

The zoom lever 202 is a center-position self-returning type lever having a wide-angle end and a telephoto end for angle adjustment. When operated by the user, the zoom lever 202 provides an operation instructing signal for driving the zoom lens 112 to the controller 130. That is to say, when the zoom lever 202 is operated to the wide-angle end, the controller 130 controls the zoom lens 112 so that a subject is recorded at the wide-angle end. Similarly, when the zoom lever 202 is operated to the telephoto end, the controller 130 controls the zoom lens 112 so that a subject is photographed at the telephoto end.

The power button 203 is a pressing-down button for switching ON/OFF of supplying of a power to respective sections composing the digital camera 100. When the power button 203 is pressed down by the user with the digital camera 100 being off, the controller 130 supplies a power to the respective sections of the digital camera 100 to activate them. Further, when the power button 203 is pressed down by the user with the digital camera 100 being on, the controller 130 stops the power supply to the respective sections.

The center button 204 is a press-down button. When the user presses down the center button 204 with the digital camera 100 being in the recording mode or the reproducing mode, the controller 130 makes the liquid crystal monitor 123 display a menu screen. The menu screen is a screen for setting various conditions for recording/reproduction of image by the user. When the center button 204 is pressed down with a setting item in the various conditions being selected, this setting item is set. That is to say, the center button 204 functions also as a determination button.

The cross buttons 205 are pressing-down buttons provided in up, down, right and left directions. When the user presses down any one of the cross buttons 205 showing any one of the directions, any one of various items displayed on the liquid crystal monitor 123 is selected.

### 2. Operation

In the slide 3D recording mode, the user moves the digital camera 100 and simultaneously photographs a subject continuously. Hereinafter, such a continuous recording in the slide 3D recording mode is referred to as “slide continuous recording”.

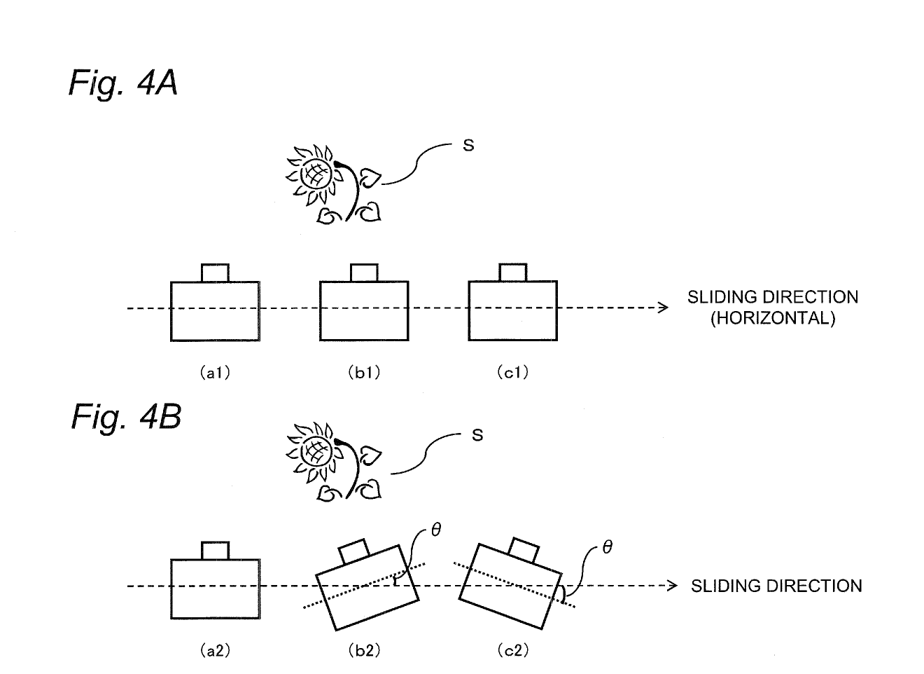

The tilt of the digital camera 100 (the rotations of the optical axis of the optical system 110 in the pitching direction and the yawing direction) that might be caused at the time of the slide continuous recording will be described. FIG. 4A is a diagram in a case where the digital camera 100 is moved ideally to a slide direction. FIG. 4B is a diagram in a case where the digital camera 100 rotates at the yawing direction with respect to the slide direction. In the case shown in FIG. 4A, among a plurality of images obtained by the slide continuous recording, a difference in the tilt (the relative tilt amount) is zero. For this reason, in the case shown in FIG. 4A, the digital camera 100 generates a three-dimensional image without taking the tilt amounts of the respective images into consideration. However, actually as shown in FIG. 4B, not a little relative tilt amount is generated among the plurality of images obtained by the slide continuous recording. When the relative tilt amount is generated, a combination of a right-eye image and a left-eye image for generating a three-dimensional image might be an unsuitable combination. That is to say, when a three-dimensional image is displayed, a combination might provide an unnatural three-dimensional image that brings a feeling of exhaustion to the user. Therefore, the digital camera 100 according to the embodiment extracts a right-eye image and a left-eye image while taking the relative tilt amount of a plurality of images into consideration so that the suitable three-dimensional image can be obtained.

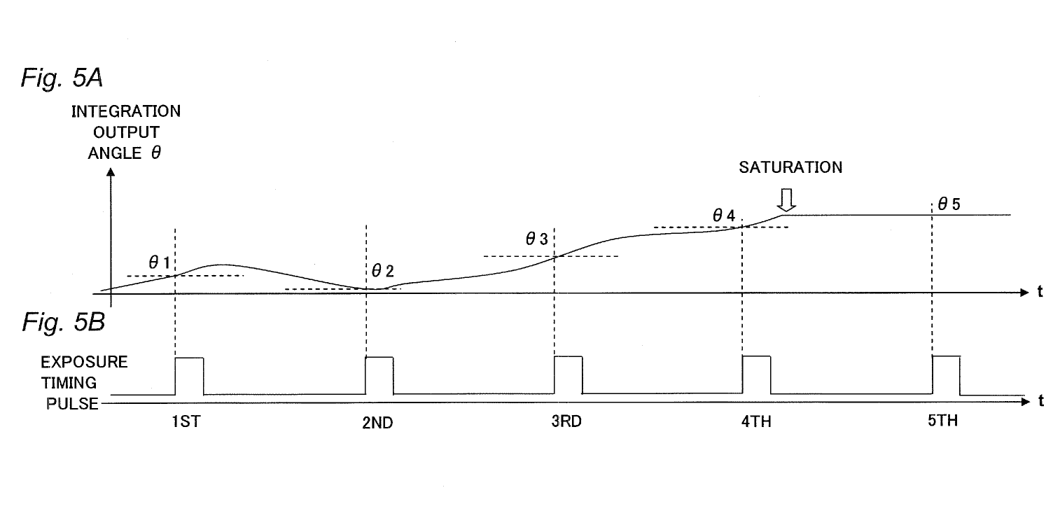

Angle information related to image recorded in the slide continuous recording will be described with reference to FIGS. 5A and 5B. FIG. 5A illustrates a waveform of a tilt angle θ of the digital camera 100 that is output by the integrating circuit 162 in the slide continuous recording. FIG. 5B illustrates a waveform of an exposure timing pulse to be supplied to the CCD image sensor 120 by the controller 130. The exposure timing pulse is used for determining timing at which the CCD image sensor 120 captures an image. Abscissa axes in FIGS. 5A and 5B represent time. The figures displayed on a lower part of FIG. 5B represent a number of images generated by the CCD image sensor 120 with the exposure timing pulse as a trigger. Further, in FIG. 5A, a tilt angle of the digital camera 100 at a time when a first image is generated is represented by θ1, and a tilt angle of the digital camera 100 at a time when a second image is generated is represented by θ2. This is true on the third and thereafter images. These angles θ1 and θ2 are related with the images generated at the respective timings and are recorded in the buffer memory 124. FIG. 5A illustrates only an angle of a yawing direction component. However as to a pitching direction component, the pitching direction component is also related with the image information similarly to the yawing direction component, and then they are stored in the buffer memory 124. For example, after the pitching direction component and the yawing direction component of the angle θ1 at the time when the first image is captured are related with the first image, they are stored in the buffer memory 124. By referring to the angle information related with the images, the controller 130 calculates the relative tilt amounts between the respective images.

Like the case in FIG. 5A where a fifth image is generated, an integrated result output from the integrating circuit 162 is occasionally not less than an upper limit that can be output from the integrating circuit 162 (hereinafter, referred to as “saturation”). In this case, the controller 130 relates error data with fifth image information, and stores the image information in the buffer memory 124. The reason why the saturated angle information is determined as error data is to prevent the saturated angle information from being compared with each other and a difference from being determined as zero.

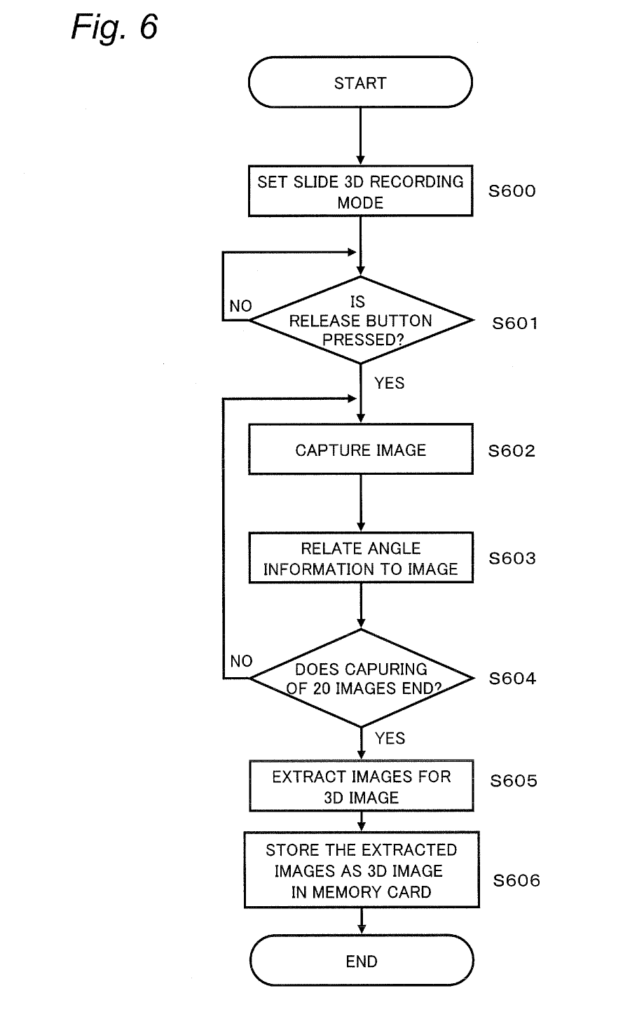

An operation of the digital camera 100 in the slide 3D recording mode will be described with reference to a flowchart of FIG. 6. When the controller 130 is set to the slide 3D recording mode, it controls the respective sections to start the slide continuous recording operation (S600). In this state, the controller 130 monitors whether the release button 201 is pressed down (S601). The controller 130 continues a monitoring state until the release button 201 is pressed down (No at S601). When the release button 201 is pressed down (Yes at S601), the controller 130 starts the slide continuous recording operation (S602).

The slide continuous recording operation may be started at the timing at which the release button 201 is pressed down, or when a predetermined time passes after the release button 201 is pressed down.

When the shutter speed is too slow at the time of the slide continuous recording, a blurred image would be easily obtained. For this reason, the controller 130 sets the shutter speed to a value faster than 1/100 sec. that is a value before starting of the slide continuous recording. When the user holds the digital camera 100 with both hands and slides the digital camera 100 from a left side to a right side so as to perform continuous recording, if the shutter speed is 1/100 sec., the number of non-blurred images is about 20. The number of continuously recorded images can be suitably changed, but hereinafter the number is 20 as one example.

At the time of the slide continuous recording, the gyro sensor 161 detects angle changes of the digital camera 100 in the pitching direction and the yawing direction per unit time. The integrating circuit 162 integrates the angle changes detected by the gyro sensor 161 to output angle information (rotation angles of the optical axis of the optical system 110 in the pitching direction and the yawing direction) to the controller 130. The controller 130 relates the image information generated by the CCD image sensor 120 and the image processor 122 with the angle information output from the integrating circuit 162 to temporarily store them in the buffer memory 124 (S603). The controller 130 relates the plurality of images generated by the continuous recording with the angle information at the timing of the generation of each image, and stores them one by one in the buffer memory 124.

The controller 130 determines whether the number of continuous recorded images reaches 20 (S604). When the number of the continuously recorded images does not reach 20 (No at S604), the controller 130 repeats steps S602 through S604 until the number of the continuously recorded images reaches 20. When the number of the continuously recorded images reaches 20 (Yes at S604), the controller 130 ends the slide continuous recording operation, and performs an operation for extracting images for a three-dimensional image (S605). In the operation for extracting images for a three-dimensional image, two images that meet predetermined conditions are extracted from the plurality of images generated in the slide continuous recording operation. The controller 130 records the extracted two images as the three-dimensional image to the memory card 140 (S606). The operation for extracting images for the three-dimensional image will be described in detail below.

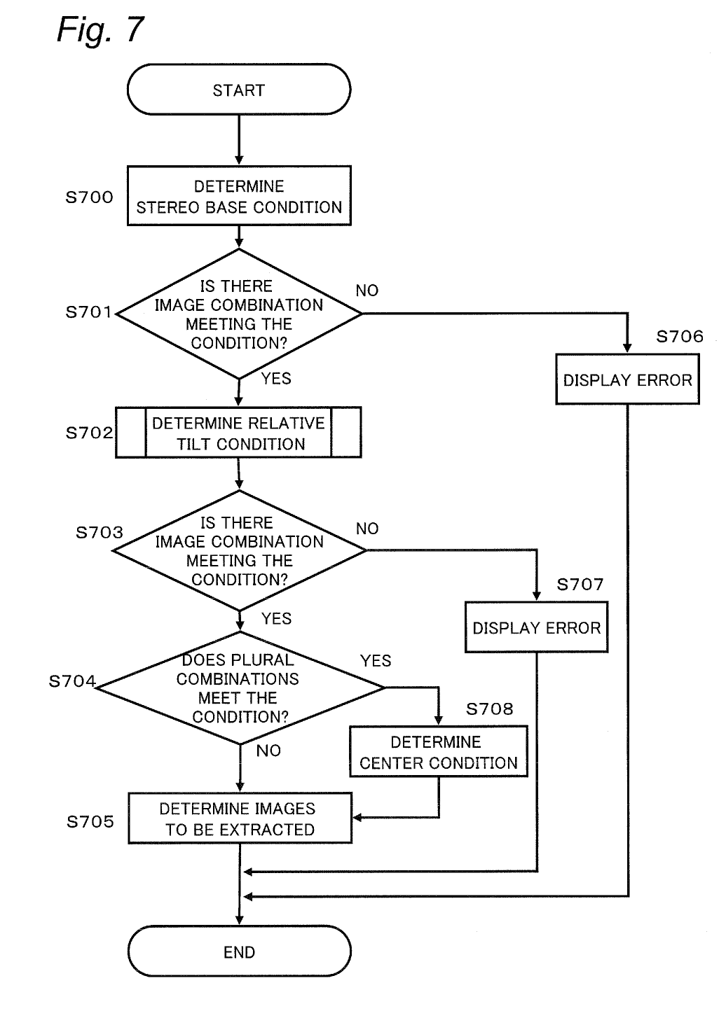

The operation for extracting images for the three-dimensional image in the slide 3D recording mode will be concretely described with reference to a flowchart of FIG. 7. The controller 130 reads the plurality of images generated by the slide continuous recording operation from the buffer memory 124. Thereafter, the controller 130 determines a displacement of pixel in a feature region among the plurality of read images. As the feature region, a focus region and a face region are adopted.

The controller 130 reads a correspondence table of the stereo base with respect to the displacement of pixel from the flash memory 142. The controller 130 determines a distance of the stereo base that corresponds to the determined displacement of pixel based on the correspondence table.

Thereafter, the controller 130 reads the reference distance information about the stereo base suitable for user's viewing of a three-dimensional image from the flash memory 142. The controller 130 determines one combination of images which provide the stereo base within an allowable distance range from the reference distance of the stereo base among a plurality of combinations of images (S700). Hereinafter, a condition that the stereo base of a combination of plural images is within the allowable distance range with respect to the reference distance is a “stereo base condition”.

The controller 130 determines whether at least one combination that meets the stereo base condition is present (S701). When the combination that meets the stereo base condition is not present (No at S701), the controller 130 makes the liquid crystal monitor 123 display an error (S706), and then ends the image extracting operation.

On the other hand, when the combination that meets the stereo base condition is present (Yes at S701), the controller 130 deletes images that are not combined with any images, and stores images that are combined with any images to the buffer memory 124. Thereafter, the controller 130 determines the relative tilt condition (S702). The controller 130 reads the images recorded in the buffer memory 124. The respective images are related with the angle information. Further, the controller 130 reads the allowable range information about the relative tilt amount from the flash memory 142. The controller 130 determines whether a difference in angle between the combined images which are determined as meeting the stereo base condition at step S700 is within the allowable range (hereinafter, referred to as “relative tilt condition”). For example, a combination of a first image and a second image in FIG. 5 meets the stereo base condition. The controller 130 determines whether the difference between θ1 and θ2 is within the allowable range. At this time, for example, even when a difference between a yawing component of θ1 and a yawing component of θ2 is smaller than a predetermined value, if a difference between a pitching component of θ1 and a pitching component of θ2 is larger than a predetermined value, the controller 130 determines that the angle difference between the combination is out of the allowable range. On the other hand, when the difference between the yawing component of θ1 and the yawing component of θ2 is smaller than the predetermined value and when the difference between the pitching component of θ1 and the pitching component of θ2 is smaller than the predetermined value, the controller 130 determines that the angle difference between the combination is within the allowable range. When the digital camera 100 is swung about a user's photographing position as a rotation axis, particularly the difference between the yawing directions becomes large. For this reason, the controller 130 is likely to determine that the relative tilt amount of the image combination captured at this time is out of the allowable range.

The controller 130 determines whether an image combination that meets the relative tilt condition is present (S703). When no image combination that meets the relative tilt condition is present (No at S703), the controller 130 displays an error on the liquid crystal monitor 123 (S707), and ends the image extracting operation.

On the other hand, when an image combination that meets the relative tilt condition is present (Yes at S703), the controller 130 determines whether a plurality of combinations meets the relative tilt condition (S704). When the plurality of combinations meets the relative tilt condition (Yes at S704), the controller 130 selects one image combination having the best condition (center condition) (S708), and adopts the combination that meets the center condition as images for generating a three-dimensional image (S705). The image combination having the best condition (center condition) is an image combination where the relative tilt amount is closest to zero. On the other hand, when only one image combination that meets the relative tilt condition is present (No at S704), the controller 130 adopts the combination as images for generating a three-dimensional image (S705).

In the above manner, the controller 130 determines the combinations that meet the stereo base condition, the relative tilt condition and the center condition (as the need arises) among a plurality of images generated by continuously recording as images for generating three-dimensional images. When the direction from the left side to the right side is adopted as the slide direction of the slide continuous recording, one image captured previously is determined as a left-eye image, and one image photographed later is determined as a right-eye image. These two images area used to realize a three-dimensional image.

### 3. Meaning of Selection in Relative Tilt

Meaning of a method for extracting a combination of images for generating a three-dimensional image from the plurality of images continuously captured in the slide 3D recording mode based on results of determining the relative tilt condition in the embodiment will be described below.

As a method for performing continuously capturing while the digital camera 100 is being slid and selecting images for generating a three-dimensional image in the slide 3D recording mode, a method for detecting whether the sliding movement is a stable panning operation (hereinafter, referred to as “panning detection”) is also present (for example, see JP2009-103980A). The digital camera that performs the panning detection adopts only images captured during the stable panning operation as images for generating a three-dimensional image. By detecting the panning in such a manner, images suitable for generating a three-dimensional image can be expected to be adopted.

However, the digital camera that detects panning cannot obtain images for generating a three-dimensional image until stable panning successfully completes. A user who is unaccustomed to the operation of the digital camera or a user who does not occasionally photograph with panning might fail in stable panning of the digital camera. Therefore, since the user who cannot handle stable panning often cannot obtain images for generating a three-dimensional image in the digital camera that detects panning, convenience of the digital camera is low.

On the other hand, according to the embodiment, even when a plurality of images are captured in a plurality of angle states during the unstable panning of the digital camera 100, a combination of images is selected based on the difference in the tilt of the digital camera 100 at the image capturing time and the stereo base condition. As a result, probability of obtaining a combination of images suitable for generating a three-dimensional image can be heightened, thereby providing the digital camera that is convenient for the user.

### 4. Summary of the Embodiment

The digital camera 100 according to the embodiment includes the CCD image sensor 120 for capturing a subject to generate an image, the gyro sensor 161 and the integrating circuit 162 for detecting a tilt angle of the digital camera 100, the buffer memory 124 for storing the images generated by the CCD image sensor 120 with the images related to angle information obtained by the gyro sensor 161 and the integrating circuit 162, and the controller 130 for selecting two images as a left-eye image and a right-eye image for generating a three-dimensional image from the plurality of images stored in the buffer memory 124 based on the angle information related to the respective images.

With such a configuration, the digital camera 100 according to the embodiment selects a combination of images for generating a three-dimensional image based on the angle information related to the respective images. As a result, even when a plurality of images are captured in the slide 3D recording mode at different angles, images suitable for generating a three-dimensional image can be obtained.

### 5. Other Embodiments

The embodiment is not limited to the above embodiment. Other embodiments will be described together below.

The above embodiment describes the CCD image sensor 120 as one example of the imaging unit, but the imaging unit is not limited to this. The imaging unit may be another imaging device such as a CMOS image sensor or an NMOS image sensor.

The above embodiment describes the gyro sensor 161 as a sensor for detecting the tilt of the digital camera 100, but the sensor for detecting the tilt is not limited to this. The sensor for detecting the tilt may be another motion sensor such as an acceleration sensor or a geomagnetic sensor.

In the digital camera 100 according to the embodiment, the slide continuous recording is performed in lateral photographing, but the orientation of the digital camera 100 is not limited to this. The digital camera 100 may be configured such that the slide continuous recording can be performed in vertical photographing. The “lateral photographing” means that the user performs photographing with the digital camera 100 being held by hands so that a short-side direction of the liquid crystal monitor 123 matches with a vertical direction. The “vertical photographing” means that the user performs photographing with the digital camera 100 being held by hands so that a long-side direction of the liquid crystal monitor 123 matches with the vertical direction. When the slide continuous recording operation is performed according to the vertical photographing, the slide direction is the short-side direction of the liquid crystal monitor 123.

The digital camera 100 according to the embodiment generates a three-dimensional image based on a plurality of images captured by continuous recording, but the invention is not limited to this. A three-dimensional image may be generated based on a plurality of images non-continuously captured while the user is changing the position of the digital camera 100. When the captured images are related to the angle information of the digital camera 100 at the capturing time, the idea of the above embodiment can be applied as the method for extracting images for generating a three-dimensional image.

In the above embodiment, the optical shake correction lens 113 may be controlled to stop its function during the slide continuous recording operation. This is because when the optical shake correction lens 113 functions during the slide continuous recording operation, images area captured with the optical shake correction lens 113 abutting against an end of a lens frame, thus deteriorating optical performance of an image to be generated. If only a function of the optical shake correction lens 113 in the direction same as the slide direction of the digital camera 100 is stopped, the slide continuous recording operation can be performed while a camera shake correcting function in a direction vertical to the slide direction is activated.

In the above embodiment, when an output dynamic range of the integrating circuit 162 is narrow, the output is easily saturated. Therefore, in this case, before the slide continuous recording operation is started, the output from the integrating circuit 162 may be reset to zero in order to avoid the saturation.

In the above embodiment, after two images for the optimum combination are selected based on the determination of the stereo base condition, images other than these two images may be deleted.

In the above embodiment, after the stereo base condition is determined (S700 in FIG. 7), the relative tilt condition is determined (S702) for the plurality of images generated at the time of the slide 3D recording mode, but the embodiment is not limited to this. After the relative tilt condition is determined, the stereo base condition may be determined. For example, as shown in FIG. 5, first (a related rotation angle is θ1) to fourth (a related rotation angle is θ4) images are obtained. At this time, the controller 130 calculates an absolute value of the difference between the rotation angle θ1 of the first image, and the rotation angle θ2 of the second image or the rotation angle θ3 of the third image or the rotation angle θ4 of the fourth image. That is, the controller 130 calculates |θ1-θ2|, |θ1-θ3| and |θ1-θ4|. Since error data is related to a fifth image, the fifth image is not subject to the calculation. Similarly, the controller 130 calculates an absolute value of the difference between the rotation angle θ2 of the second image, and the rotation angle θ3 of the third image or the rotation angle θ4 of the fourth image. That is, the controller 130 calculates |θ2-θ3| and |θ2-θ4|. Similarly, the controller 130 calculates an absolute value of the difference between the rotation angle θ3 of the third image and the rotation angle θ4 of the fourth image, finally. That is, the controller 130 calculates |θ3-θ4|. This difference in the rotation angle is the relative tilt amount between the images. The controller 130 extracts a combination of images whose relative tilt amount falls within the allowable range based on the respective calculated absolute values of the relative tilt amounts. For example, the values of |θ1-θ2|, |θ2-θ4| and |θ3-θ4| are within the allowable range. At this time, the controller 130 determines the stereo base condition for the combinations related to |θ1-θ2|, |θ2-θ4| and |θ3-θ4|, so that the combinations that meet this condition are finally adopted as the combination of images for generating a three-dimensional image. In short, the operations of the controller 130 may include the operation for adopting the combinations of images that meet the relative tilt condition from a plurality of images continuously captured in the slide 3D recording mode as the combination of images for generating a three-dimensional image. The order of this determining operation and the other determining operation is not limited.

Further, the embodiment can be applied even to a camera incorporating a lens therein and a lens-interchangeable camera.

### INDUSTRIAL APPLICABILITY

The above embodiment can be applied to imaging apparatuses such as a digital camera, a movie camera, and an information terminal with a camera.

What is claimed is:

1. An imaging apparatus, comprising:
an imaging unit configured to capture a subject to generate an image;
a detector configured to detect tilt of the imaging apparatus;
a storage unit configured to store the images generated by the imaging unit with the images being related to the detection results of the detector; and
a controller configured to select at least two images as images for generating a three-dimensional image from the plurality of images stored in the storage section based on the detection results related to the images.

2. The imaging apparatus according to claim 1, wherein the controller selects, as the images for generating the three-dimensional image, two images that provide a difference between the two images in the tilt represented by the detection result related to the respective images, and the difference is within a predetermined range.

3. The imaging apparatus according to claim 1, wherein the imaging unit has a recording mode for continuously capturing a subject image to continuously generate a plurality of images.

4. The imaging apparatus according to claim 2, wherein the imaging unit has a recording mode for continuously capturing a subject image to continuously generate a plurality of images.
